(19) United States
(12) Patent Application Publication
(10) Pub. No.: US 2003/0156499 A1
(43) Pub. Date: Aug. 21, 2003

(54) Method of improving the transparency of scratched dial covers and repair kit

(76) Inventor: Brian D. Miller, Louisville, KY (US)

Correspondence Address: David W. Carrithers, CARRITHERS LAW OFFICE, One Paragon Centre, 6060 Dutchman's Lane, Suite 140, Louisville, KY, 40205, US

(21) Appl. No.: 10/192,384

(22) Filed: Jul. 10, 2002

Related U.S. Application Data
(60) Provisional application No. 60/357,429, filed on Feb. 15, 2002.

(51) Int. Cl. G04B 37/00; G04B 39/00

(52) U.S. Cl. 368/296

(57) ABSTRACT

The transparency of a watch crystal having scratches in the outer surface is improved by applying thereto a piece of a thermoplastic urethane film. The film has an acrylic adhesive on one surface and a protective clear coat on the other surface. The scratched cover of the watch crystal and the adhesive is thoroughly wetted with an alcohol water solution (25% alcohol, 75% water). The film is then placed on the scratched cover and stretched to cover and conform to the surface thereof. Pressure is then applied to the film to drive out from thereunder excess of the water alcohol solution. After a short drying period the watch is ready for use.

### BACKGROUND OF THE INVENTION

1. Technical Field

This invention relates particularly to a method and apparatus for restoring the transparency of defaced watch crystals but is applicable to other portable devices having a transparent dial covers overlying a face that is eye readable through the cover and wherein the covers transparency is reduced due to scratches as result of use such as a gauge face or clock face.

2. Background Information

Watch crystals and dial covers are comprised of glass; plastics such as polyvinyl chloride, polyethylene, and polycarbonate; a mineral crystal; and synthetic materials such as a corridum crystal. The mineral crystals such as are sold under the brand name of HARD-LEX are more commonly used because of being cheaper, lighter and more easily shaped to match that of the watch face. Mineral crystals and plastics material crystals are softer than glass and thus more prone to having the surface thereof scratched during use. The transparency of the crystal is reduced with each scratch as is also the reflectivity. The loss of transparency makes it difficult to see the watch or gauge face and the loss of reflectivity reduces the aesthetic qualities as one normally associates a bright shiny crystal with a new watch and a dull crystal with an old watch. A severely scratched crystal can obscure the watch or gauge face to the extent that it becomes difficult, if not impossible, to read the time indicated by the time piece except under bright light conditions.

There are known proposals for preventing scratching the surface of a watch crystal that include applying a protective film to the outer surface of the crystal and by way of example reference maybe had to the following United States Utility Patents: U.S. Pat. No. 4,684,264 granted Aug. 4, 1987 to Steven H. Paperno et al entitled Protective Overlay for Watch Crystal, and U.S. Pat. No. 4,509,644 granted Apr. 9, 1985 to John M. Kulick entitled Watch Crystal Cover and Package Assembly.

In each instance the protective cover is a film of a plastics material and is attached to the crystal without an adhesive as taught in the above Paperno et al. patent or with an adhesive as disclosed in the above Kulick patent. The sole purpose of the cover is to protect the crystal against scratching or chipping and thereby prolong the life of the crystal. In the Paperno et al. patent the overlay is decorative in addition to being protective. The protective film must be applied before any scratches occur if one is to get the benefits of the invention as taught by the patentees.

Neither of the foregoing patentees address the issue of rejuvenating a watch crystal after the crystal has been scratched and applicant is not aware of anyone else that has addressed that issue. In most instances damaged crystals are replaced instead of being repaired or in many instances the time piece is merely discarded and replaced with a new one.

### SUMMARY OF INVENTION

A principal object of the present invention is to provide a simple inexpensive means of rejuvenating scratched watch crystals or other transparent faces of gauges, clocks, instruments and the like.

An object of the present invention is to improve the transparency of watch crystals having scratches on the face thereof.

A further principal object of the present invention is to provide a kit for rejuvenating scratched crystals in which the kit includes a variety of differently sized film pieces for applying to the scratched face of the crystal.

In keeping with the forgoing there is provided in accordance with one aspect of the present invention a method of rejuvenating a transparent cover having scratches in the surface thereof that have reduced the transparency of the cover comprising:

(a) providing a piece of a thermoplastic film having a protective clear coat on one surface thereof and an acrylic adhesive on the opposite surface that is releasably attached to a liner,

(b) providing a water alcohol solution,

(c) removing the film piece from the backing,

(d) wetting the adhesive surface of the film piece and the covers scratched surface with said water alcohol solution,

(e) placing the film piece over the scratched surface of the cover with the adhesive in face-to-face contact therewith,

(f) while firmly holding the film piece in position stretching the same to fit over the surface of the cover, and

(g) apply pressure to the outer surface of the film piece to squeeze out excess of the alcohol water solution from between the film and cover surface.

In accordance with a further aspect of the present invention there is provided a kit for use in repairing crystal faces having scratches on the surface thereof that reduce the transparency of the crystal comprising: a sheet having a plurality of film pieces removably mounted thereon, each said film piece consisting of a thermoplastic urethane film having a clear coat on one surface thereof and an acrylic adhesive on the opposite surface, said adhesive releasably adhering the film piece to said sheet, and a container having a water alcohol solution therein.

### BRIEF DESCRIPTION OF THE DRAWINGS

A better understanding of the present invention will be had upon reference to the following description in conjunction with the accompanying drawings in which like numerals refer to like parts throughout the several views and wherein:

FIG. 1 is a plan view of a wrist watch face having scratches on the outer surface of the crystal;

FIG. 2 is a plan view of the same watch face in FIG. 1 which has been rejuvenated by having a film piece on the surface thereof in accordance with the present invention;

FIG. 3 is a plan view of a watch face similar to FIG. 2 but with the film piece covering only a portion of the surface of the crystal;

FIG. 4 is a plan view of a page containing a plurality of variously sized film pieces for differently sized crystal faces and is part of a kit provided in accordance with the present invention for rejuvenating watch crystals; and

FIG. 5 is a partial sectional view along the line 5-5 in FIG. 3 but on a larger scale.

### DESCRIPTION OF THE PREFERRED EMBODIMENTS

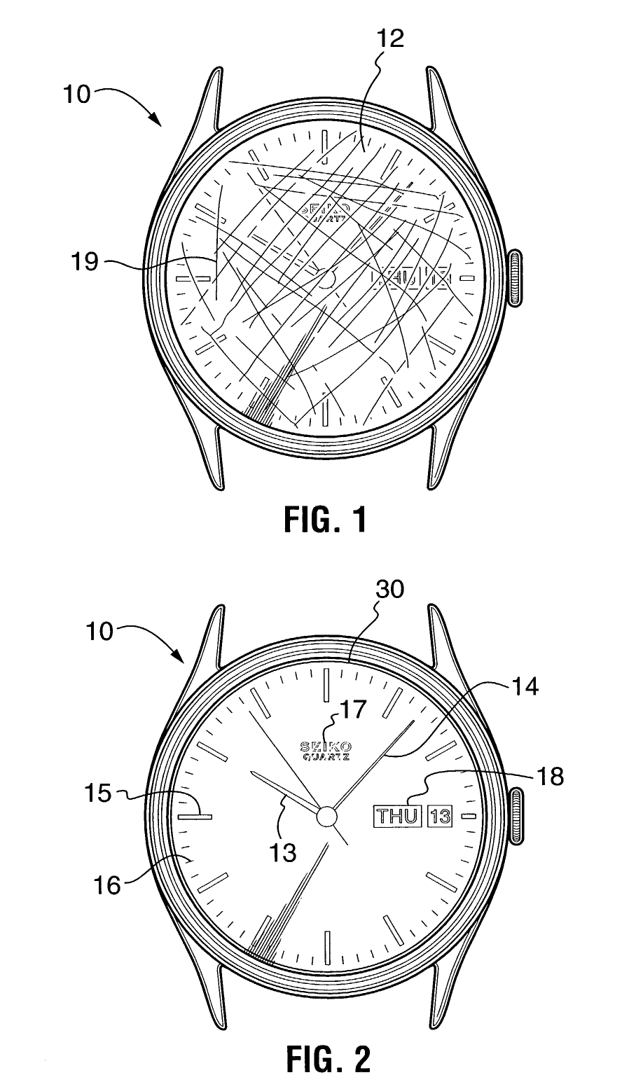

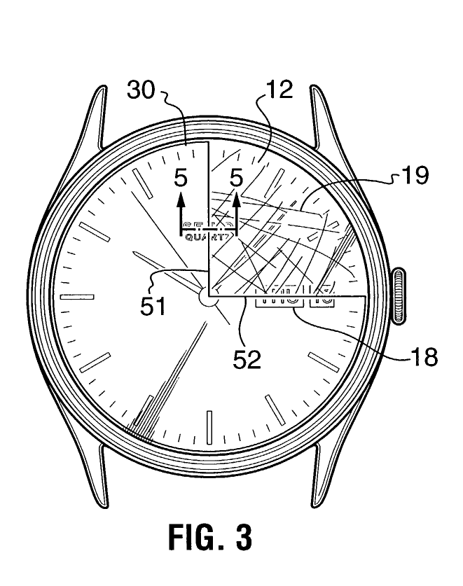

Referring to FIGS. 1-3 there is illustrated the front face portion of a wrist watch 10 which includes a crystal 12 overlying the watch hands 13, 14 and a dial face 11 on which there are respective hour and minute markings 15 and 16, the makers name 17, in this instance being SEIKO, and a day-day of the month dial 18. The eye readability of the markings etc is dependent upon the transparency of the crystal 12 and this is reduced substantially by surface scratches 19 on the outer face of the crystal as is illustrated by way of example in FIGS. 1 and 3.

In accordance with the present invention the transparency of the scratched crystal of FIG. 1 is substantially increased, as is illustrated by way of example in FIGS. 2 and 3, by attaching a piece 30 of a film of a plastics material to the scratched surface of the crystal. Applicant has discovered that a known film material designed and used for other purposed has a dramatic affect in improving the transparency of scratched watch crystals. The film is a known paint protection film, available from the 3M Corporation, and is applied to vehicle painted surfaces to protect against stone chips, bug damage, abrasion and weathering of vehicle painted surfaces while allowing the color brilliance to show through. The product is sold under the Trademark SCOTCHCAL and is described in a product bulletin 1-45 dated October 1999 of the Automotive Aftermarket Division of 3M.

The product is described as a high performance protective film comprising a urethane that is yellow resistant. The brochure describes the product as being a durable, flexible, conformable film and easy to apply. The product comprises a thermoplastic urethane film 31 (see FIG. 5) having a clear coat 32 applied to one surface thereof and an Acrylic PSA adhesive 33 applied to the opposite surface. A release liner of white bleached paper (not shown) with a release coating thereon overlies the adhesive surface and remains thereon until removed by the user just prior to placing the film piece on the crystal. The product is sold under the designation PUL 0612 in which the thermoplastic urethane is 152 u, 6 mil or the designation PUL 1212 in which the thermoplastic urethane is 305 u, 12 mil.

A piece of the film is cut to conform to the shape of but slightly smaller than that of the crystal to be rejuvenated. The liner is then peeled from the adhesive face of the film and a liberal amount of an alcohol water solution (25% alcohol and 75% water) is sprayed onto both the adhesive face of the film and the face of the crystal face that is scratched. The film is then placed lightly on the crystal with the adhesive face of the film contacting the scratched face of the crystal. The film is then stretched over the crystal face starting preferably at the center and working one's way out to the periphery. Once the film piece is in position any excess solution is squeegeed out to remove any bubbles.

As illustrated in FIG. 2 the watch face is clear with the makers name, the hour and minute markings and the watch hands all being clearly visible and this has resulted from a piece of the foregoing described film being applied to the surface of the scratched face of the watch crystal shown in FIG. 1 and wherein the entire watch face is blurred to the extent that the day-day of the month dial is illegible. The comparison is further illustrated in FIG. 3 wherein the film as illustrated in FIG. 2 is removed from a quarter segment of the face within the area bounded by the broken lines 51 an 52.

A badly scratched hardened mineral crystal (standard used in the majority of watches produced) was subjected to a light transmittance test using a Shimadzu UV 1601 PC Spectrophotometer instrument before and after the application of a piece of the foregoing described film for a test range of 300 nm-600 nm (visible light) and the following results were obtained:

| | | |
|---|---|---|
| Scan 1 | Scan 2 | Scan 3 |

Badly Scratched Hardened Mineral Crystal

| | | | |
|---|---|---|---|
| 300 nm | 3.2% | 3.2% | 3.2% |
| 350 nm | 34.7% | 34.8% | 34.8% |
| 400 nm | 57.2% | 56.4% | 56.3% |
| 450 nm | 37.3% | 37.2% | 37.1% |
| 500 nm | 66.7% | 66.3% | 66.6% |
| 550 nm | 49.2% | 49.2% | 49.2% |
| 600 nm | 41% | 41.0% | 41.0% |

Same Crystal having Film Applied thereto

| | | | |
|---|---|---|---|
| 300 nm | 0% | 0% | 0% |
| 350 nm | 0% | 0% | 0% |
| 400 nm | 87.6% | 87.6% | 87.6% |
| 450 nm | 76.6% | 76.6% | 76.6% |
| 500 nm | 77.7% | 77.7% | 77.7% |
| 550 nm | 110.\hat{ }% | 110.6% | 110.6% |
| 600 nm | 92.1% | 92.1% | 92.1% |

Film Material only not Applied to Watch Crystal

| | | | |
|---|---|---|---|
| 300 nm | 0% | 0% | 0% |
| 350 nm | 0% | 0% | 0% |
| 400 nm | 87.6% | 87.6% | 87.6% |
| 450 nm | 76.6% | 76.6% | 76.6% |
| 500 nm | 77.7% | 77.7% | 77.7% |
| 550 nm | 108.0% | 108.0% | 108.5% |
| 600 nm | 89.5% | 89.5% | 89.5% |

The foregoing clearly shows improvements in the transparency of a scratched watch crystal when a piece of a film as previously described is applied to overlie the scratched face.

In accordance with a further aspect of the present invention there is provided a kit for use in rejuvenating scratched watch crystals. The kit includes an assortment precut pieces of the forgoing described film carried by a suitable backing e.g a sheet punched to fit a three ring binder. The pieces are pre-sized and pre-shaped to match crystals of various sizes and shapes. The shapes are round, rectangular or square. One sheet for example may contain 5 circular pieces of film for each 0.5 mm increment of size ranging from 15 mm to 20 mm and another sheet may contain rectangular shaped pieces while another sheet may contain square shaped pieces or one sheet may contain an assortment of shapes in various sizes. Watch crystals come in various common sizes and shapes and the film pieces are supplied with a range so that the user can choose one that corresponds in shape to that of the crystal to be repaired and slightly smaller in size than the same.

The principal component of the kit is the sheet having a plurality of film pieces thereon that are precut to selected sizes and ready for use after being peeled from the sheet and a supply of an alcohol water solution consisting of 25% alcohol and 75% water. The alcohol water solution can contain up to 50% alcohol, but typically comprises an alcohol water solution having in a range of from about 20-30 percent alcohol and from 70 to 80 percent water.

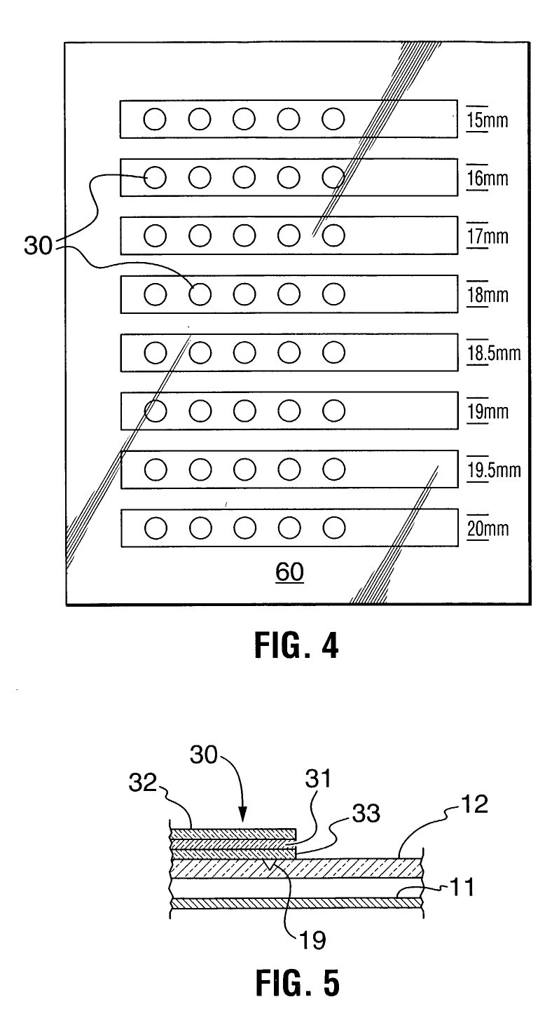

FIG. 4 illustrates a sheet 60 having a plurality of variously sized round film pieces 30 thereon. By way of example the sheet contains a plurality of pieces in each of 8 rows of respective diameters of 15 mm, 16 mm, 17 mm, 18 mm, 18.5 mm, 19 mm, 19.5 mm and 20 mm. The preferred method is to select a film piece that is 0.5 mm smaller than that of the crystal to be repaired.

Other components for each kit includes a measuring device e.g. a metric ruler and a sheet of instructions with the instructions being as follows:

1. Using a millimeter gauge, measure the watch crystal and round the number downward to the nearest half millimeter. (For example, if the crystal measures approximately 28.8 mm you will use a 25.5 mm piece of film). Make sure to measure the crystal only and not the thin plastic compression ring outside of the crystal.

2. Clean the watch crystal with a glass cleaner. Be sure there are no smudges or lint left on the crystal.

3. Select appropriate size film piece, flex paper and using finger nail carefully lift up edge. Once enough edge is raised use tweezers to carefully lift the film piece from the backing paper.

4. Place several drops of the alcohol and water solution on the adhesive side of the film piece. Use enough solution to cover the adhesive side. Shake off excess solution.

5. Carefully lay the film piece on the watch crystal by starting at the 12 o'clock position and evenly laying it downward. Make sure it is centered. (Avoid getting any moisture near stem and crown).

6. With thumb hold the outer edge of the film piece securely against the watch crystal.

7. Wet opposite thumb and starting just below the dry thumb securing the outer edge carefully use your wet thumb to press against the film piece working downward and outward to force the alcohol and water solution out from underneath. Avoid forcing the solution toward areas that are already secured. Make sure there are no bubbles left behind.

8. Carefully dry the watch.

9. If you need to recenter, slowly and carefully, pull the film piece off, rewet and redo.

10. Wait half hour before wearing the watch.

Do not touch the adhesive side of the film piece with dry fingers as this will leave finger prints that will not come out.

While the foregoing is specific with respect to rejuvenating watch crystals there are other useful applications such a machine and apparatus instrument gauges that have a transparent cover that is subject to becoming scratched though extended use such as binoculars. Another example is a tire air pressure gauge and there will be numerous others apparent to those skilled in the art. The transparency of a transparent lens cover having imperfections in the surface thereof at the time of manufacture can be improved by applying thereto a film piece as described in the foregoing using a watch crystal for the example.

The foregoing detailed description is given primarily for clearness of understanding and no unnecessary limitations are to be understood therefrom, for modifications will become obvious to those skilled in the art based upon more recent disclosures and may be made without departing from the spirit of the invention and scope of the appended claims.

I claim:

1. A method of rejuvenating a transparent cover having scratches in the surface thereof that have reduced the transparency of the cover comprising the steps of:
(a) providing a piece of a thermoplastic film having a protective clear coat on one surface thereof and an acrylic adhesive on the opposite surface that is releasably attached to a liner,
(b) providing a water alcohol solution,
(c) removing the film piece from the backing,
(d) wetting the adhesive surface of the film piece and the covers scratched surface with said water alcohol solution,
(e) placing the film piece over the scratched face of the cover with the adhesive in face-to-face contact therewith,
(f) while firmly holding the film piece in position stretching the same to fit over the face of the cover, and
(g) apply pressure to the outer surface of the film piece to squeeze out from thereunder any surplus alcohol water solution.

2. The method of claim 1 wherein the cover is a watch crystal and the film piece is pre-shaped to correspond to that of the watch crystal being repaired.

3. The method of claim 2 wherein said film piece is pre-sized so as to be a selected amount smaller than the watch crystal being repaired.

4. The method of claim 2 wherein said film piece is provided in a kit comprising a plurality of variously sized film pieces releasably mounted on a backing sheet.

5. The method of claim 2 where said alcohol water solution is up to 50% alcohol.

6. The method of claim 2 where said alcohol water solution is in a range of from about 20-30 percent alcohol and from 70 to 80 percent water.

7. The method of claim 2 where said alcohol water solution is 25% alcohol and 75% water.

8. A scratched watch crystal repaired by the method of claim 2.

9. A kit for use in repairing watch crystals having scratches on the surface thereof that reduce the transparency of the crystal comprising:
(a) a sheet having a plurality of film pieces removably mounted thereon, each said film piece consisting of a thermoplastic urethane film having a clear coat on one surface thereof and an acrylic adhesive on the opposite surface, said adhesive releasably adhering the film piece to said sheet, and
(b) a container having a water alcohol solution therein.

10. A kit as defined in claim 6 wherein said film pieces on said sheet are of preselected shape and vary in size within a selected range.
